(19) United States
(12) Patent Application Publication
(10) Pub. No.: US 2020/0149901 A1
(43) Pub. Date: May 14, 2020

(54) COURSE PROPOSAL DEVICE, COURSE PROPOSAL METHOD, AND PROGRAM

(71) Applicant: TOYOTA JIDOSHA KABUSHIKI KAISHA, Toyota-shi (JP)

(72) Inventor: Jun ENDO, Nagoya-shi (JP)

(73) Assignee: TOYOTA JIDOSHA KABUSHIKI KAISHA, Toyota-shi (JP)

(21) Appl. No.: 16/573,202

(22) Filed: Sep. 17, 2019

(30) Foreign Application Priority Data
Nov. 8, 2018 (JP) 2018-210878

(51) Int. Cl. G01C 21/34; G06Q 50/14

(52) U.S. Cl. CPC G01C 21/3415; H04L 67/12; G01C 21/3484; G06Q 50/14

(57) ABSTRACT

A course proposal device includes a visit proposal place extraction unit configured to extract a plurality of places present within a predetermined distance from a travel route to a destination as visit proposal places, an information acquisition unit configured to acquire information indicating a degree of interest of a user in the visit proposal place, a degree-of-interest change decision unit configured to decide whether or not a degree of interest has changed with a change in an environment, and a course proposal unit configured to determine a course to be proposed to the user based on the degree of interest, and the course proposal unit determines a course to be newly proposed to the user based on the changed degree of interest when the degree-of-interest change decision unit decides that the degree of interest has changed.

### INCORPORATION BY REFERENCE

The disclosure of Japanese Patent Application No. 2018-210878 filed on Nov. 8, 2018 including the specification, drawings and abstract is incorporated herein by reference in its entirety.

### BACKGROUND

### 1. Technical Field

The present disclosure relates to a course proposal device, a course proposal method, and a program.

### 2. Description of Related Art

In recent years, a system that supports creation of a course of a trip or the like and provides an alternative course according to a behavior of a user has been developed. For example, Japanese Unexamined Patent Application Publication No. 2016-143192 (JP 2016-143192 A) discloses a system that estimates an arrival time of a user to a scheduled visit facility, searches for another facility when deciding that the user cannot arrive at an original scheduled time arrival, and proposes an alternative course to the user.

### SUMMARY

A degree of interest of the user in a facility originally scheduled for visit may be reduced due to external factors such as weather or a degree of congestion of the facility. However, in the system disclosed in JP 2016-143192 A, when a course is in time for a scheduled arrival time of a facility, an alternative course cannot be proposed to the user when a degree of interest in the facility has already been reduced.

The present disclosure made in view of such circumstances and provides a course proposal device capable of proposing a new course to a user in consideration of a change in a degree of interest of the user in a place (a facility, a store, a sightseeing spot, or the like) scheduled for visit, and a program.

A first aspect of the present disclosure relates to a course proposal device. The course proposal device includes a visit proposal place extraction unit configured to extract a plurality of places present within a predetermined distance from a travel route to a destination as visit proposal places; an information acquisition unit configured to acquire information indicating a degree of interest of a user in the visit proposal place; a degree-of-interest change decision unit configured to decide whether or not the degree of interest has changed with a change in an environment; and a course proposal unit configured to determine a course to be proposed to the user based on the degree of interest, wherein the course proposal unit determines a course to be newly proposed to the user based on the changed degree of interest when the degree-of-interest change decision unit decides that the degree of interest has changed.

A second aspect of the present disclosure relates to a course proposal method. The course proposal method includes a visit proposal place extraction step of extracting a plurality of places present within a predetermined distance from a travel route to a destination as visit proposal places; an information acquisition step of acquiring information indicating a degree of interest of a user in the visit proposal place; a degree-of-interest change decision step of deciding whether or not the degree of interest has changed with a change in an environment; and a course proposal step of determining a course to be proposed to the user based on the degree of interest, wherein the course proposal step includes determining a course to be newly proposed to the user based on the changed degree of interest when a decision is made in the degree-of-interest change decision step that the degree of interest has changed.

A third aspect of the present disclosure relates to a program. The program causes a computer functioning as a course proposal device to execute: a visit proposal place extraction step of extracting a plurality of places present within a predetermined distance from a travel route to a destination as visit proposal places; an information acquisition step of acquiring information indicating a degree of interest of a user in the visit proposal place; a degree-of-interest change decision step of deciding whether or not the degree of interest has changed with a change in an environment; and a course proposal step of determining a course to be proposed to the user based on the degree of interest, wherein the course proposal step includes determining a course to be newly proposed to the user based on the changed degree of interest when a decision is made in the degree-of-interest change decision step that the degree of interest has changed.

According to the present disclosure, it is possible to propose a new course to the user when the degree of interest of the user in the place scheduled for visit has changed.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram illustrating an overview of a course proposal system including a course proposal device according to an embodiment of the present disclosure;

FIG. 2 is a block diagram illustrating a schematic configuration of a vehicle;

FIG. 3 is a block diagram illustrating a schematic configuration of a terminal device;

FIG. 4 is a block diagram illustrating a schematic configuration of a course proposal device;

FIG. 5 is a diagram illustrating an example of a display of information on a visit proposal place in a terminal output unit;

FIG. 6 is a diagram illustrating a first example of determining a course;

FIG. 7 is a diagram illustrating a second example of determining a course;

FIG. 8 is a diagram illustrating a third example of determining a course;

FIG. 9 a flowchart illustrating an overview of a course proposal method according to an embodiment of the present disclosure; and

FIG. 10 is a flowchart illustrating an example of a course determination method.

### DETAILED DESCRIPTION OF EMBODIMENTS

Hereinafter, embodiments of the present disclosure will be described in detail with reference to the drawings.

Course Proposal System

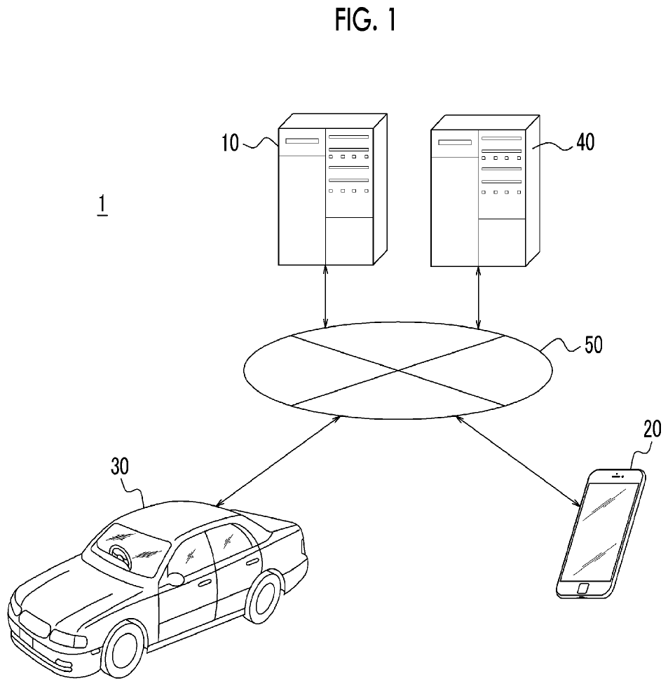

An overview of a course proposal system 1 including a course proposal device 10 according to an embodiment of the present disclosure will be described with reference to FIG. 1. The course proposal system 1 includes a course proposal device 10, a terminal device 20, and a vehicle 30. The terminal device 20 is, for example a general-purpose electronic device such as a smartphone or a personal computer (PC). However, the terminal device 20 is not limited thereto, and may be an electronic device dedicated to the course proposal system 1. The vehicle 30 is, for example, an automobile, but is not limited thereto and may be any vehicle. Although solely one terminal device 20 and one vehicle 30 are illustrated in FIG. 1 for simplicity of the description, the number of terminal devices 20 and vehicles 30 included in the course proposal system 1 may be one or more. Each of the course proposal device 10, the terminal device 20, and the vehicle 30 is communicatively connected to a network 50 including, for example, a mobile communication network and the Internet. Further, as illustrated in FIG. 1, the course proposal system 1 may include an SNS server 40 connected to the network 50.

Next, each configuration of the course proposal system 1 will be described in detail.

Configuration of Vehicle

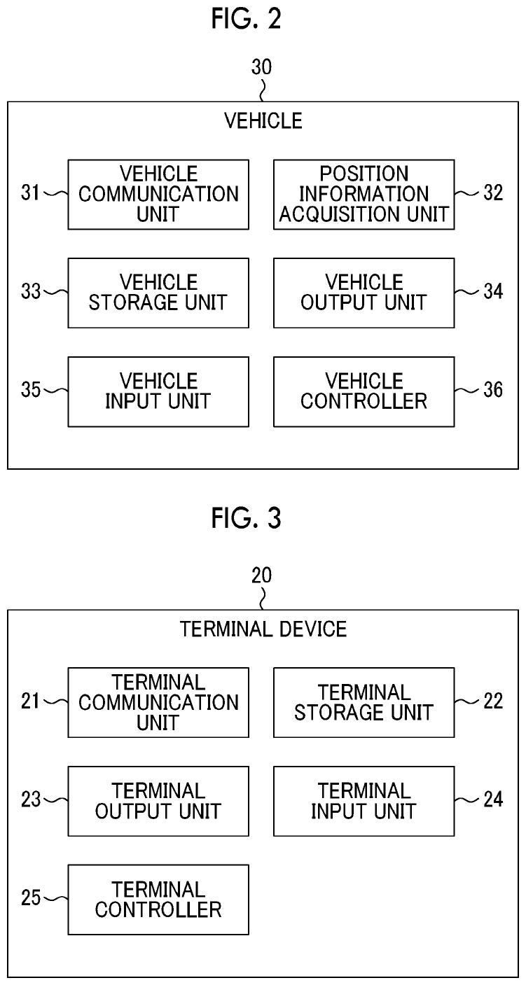

FIG. 2 is a block diagram illustrating a schematic configuration of the vehicle 30. As illustrated in FIG. 2, the vehicle 30 includes a vehicle communication unit 31, a position information acquisition unit 32, a vehicle storage unit 33, a vehicle output unit 34, a vehicle input unit 35, and a vehicle controller 36.

The vehicle communication unit 31 is, for example, an in-vehicle communication device such as a data communication module (DCM). Specifically, the vehicle communication unit 31 includes a processor, a memory, and a communication module connected to the network 50. The communication module corresponds to, for example, mobile communication standards such as 4G (4th Generation) and 5G (5th Generation), but is not limited thereto. In the embodiment, the vehicle 30 is connected to the network 50 via the vehicle communication unit 31.

The position information acquisition unit 32 is a device that acquires position information of the vehicle 30. Specifically, the position information acquisition unit 32 includes a receiver corresponding to a satellite positioning system. For example, the receiver corresponds to a global positioning system (GPS). In the embodiment, the vehicle 30 acquires position information of the vehicle using the position information acquisition unit 32.

The vehicle storage unit 33 includes one or more memories. In the embodiment, the “memory” is, for example, a semiconductor memory, a magnetic memory, or an optical memory, but is not limited thereto. Each memory included in the vehicle storage unit 33 may function as, for example, a main storage device, an auxiliary storage device, or a cache memory. The vehicle storage unit 33 stores any information used for an operation of the vehicle 30. For example, the vehicle storage unit 33 may store a system program, an application program, road traffic information, road map information, and the like. The information stored in the vehicle storage unit 33 may be updatable with information acquired from the network 50 via the vehicle communication unit 31, for example.

The vehicle output unit 34 includes one or more output interfaces that output information to notify the user of the information. For example, the output interface included in the vehicle output unit 34 is a display that outputs information as an image, a speaker that outputs information by audio, or the like, but is not limited thereto. For example, the display is a panel display or a head-up display, but is not limited thereto.

The vehicle input unit 35 includes one or more input interfaces that detect a user input. For example, the input interface included in the vehicle input unit 35 is a physical key, a capacitance key, a touch screen integrally provided with a panel display of the vehicle output unit 34, or a microphone that receives an audio input, but is not limited thereto.

The vehicle controller 36 includes one or more processors. In the embodiment, the “processor” is a general-purpose processor or a dedicated processor specialized for a specific process, but is not limited thereto. For example, an electronic control unit (ECU) mounted in the vehicle 30 may function as the controller 17. The vehicle controller 36 controls an entire operation of the vehicle 30.

Configuration of Terminal Device

FIG. 3 is a block diagram illustrating a schematic configuration of the terminal device 20. As illustrated in FIG. 3, the terminal device 20 includes a terminal communication unit 21, a terminal storage unit 22, a terminal output unit 23, a terminal input unit 24, and a terminal controller 25.

The terminal communication unit 21 includes a communication module connected to the network 50. For example, the terminal communication unit 21 may include a communication module compatible with mobile communication standards such as 4G and 5G In the embodiment, the terminal device 20 is connected to the network 50 via the terminal communication unit 21.

The terminal storage unit 22 includes one or more memories. Each memory included in the terminal storage unit 22 may function as, for example, a main storage device, an auxiliary storage device, or a cache memory. The terminal storage unit 22 stores any information used for an operation of the terminal device 20. The information stored in the terminal storage unit 22 may be updatable with, for example, information acquired from the network 50 via the terminal communication unit 21.

The terminal output unit 23 includes one or more output interfaces that output information and notify the user of the information. For example, the output interface included in the terminal output unit 23 is a display that outputs information as a video, a speaker that outputs information as an audio, or the like, but is not limited thereto.

The terminal input unit 24 includes one or more input interfaces that detect user input. For example, the input interface included in the terminal input unit 24 is a physical key, a capacitance key, a touch screen provided integrally with a display of the terminal output unit 23, a microphone that receives an audio input, or the like, but is not limited thereto.

The terminal controller 25 includes one or more processors. The terminal controller 25 controls an entire operation of the terminal device 20.

(Configuration of Course Proposal Device)

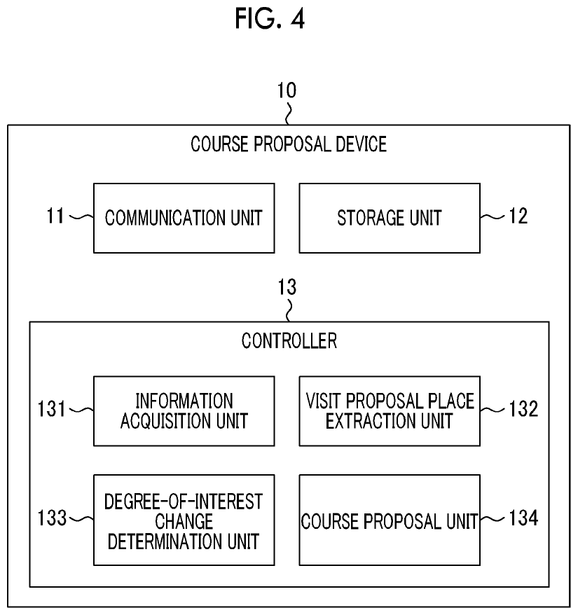

FIG. 4 is a block diagram illustrating a schematic configuration of the course proposal device 10. As illustrated in FIG. 4, the course proposal device 10 includes a communication unit 11, a storage unit 12, and a controller 13. The course proposal device 10 may be a center or may be a cloud server.

The communication unit 11 includes one or more communication modules connected to the network 50. For example, the communication unit 11 may include a communication module corresponding to a wired local area network (LAN) standard. In the embodiment, the course proposal device 10 is connected to the network 50 via the communication unit 11.

The storage unit 12 includes one or more memories. Each memory included in the storage unit 12 may function as, for example, a main storage device, an auxiliary storage device, or a cache memory. The storage unit 12 stores any information used for an operation of the course proposal device 10. For example, the storage unit 12 may store a system program, an application program, road traffic information, road map information, and the like. The information stored in the storage unit 12 may be updatable with, for example, information acquired from the network 50 via the communication unit 11.

The controller 13 includes one or more processors. The controller 13 controls an entire operation of the course proposal device 10. Specifically, the controller 13 includes an information acquisition unit 131, a visit proposal place extraction unit 132, a degree-of-interest change decision unit 133, and a course proposal unit 134.

The information acquisition unit 131 acquires various types of information via the communication unit 11. The information acquisition unit 131 acquires schedule information for going out using the vehicle 30, and outputs the schedule information to the visit proposal place extraction unit 132. For example, when the schedule information is stored in the terminal storage unit 22 of the terminal device 20, the information acquisition unit 131 acquires the schedule information from the terminal device 20. When the schedule information is stored in an external server that provides the schedule management service to be used by a user, the information acquisition unit 131 acquires the schedule information from the external server. The schedule information may include at least a departure date and a destination, and is, for example, reservation information of a hotel. Further, the information acquisition unit 131 acquires information of a departure point when an action according to schedule information is performed, and outputs information on the departure point to the visit proposal place extraction unit 132. For example, the information acquisition unit 131 may acquire the information on the departure point from the terminal device 20, or may acquire position information of the vehicle 30 from the vehicle 30 and use the position information as the information on the departure point. When the user makes a reservation for a rental car or car sharing, the information acquisition unit 131 acquires a place at which the user rents the vehicle 30 as the information on the departure point.

Further, the information acquisition unit 131 acquires degree-of-interest information to be described below from the terminal device 20, and outputs the degree-of-interest information to the course proposal unit 134. Further, the information acquisition unit 131 acquires weather information, road traffic information, congestion information of a visit proposal place, and the like from the external server, and outputs the information to the degree-of-interest change decision unit 133. Further, the information acquisition unit 131 may acquire SNS information of the user from the SNS server 40 and output the SNS information to the visit proposal place extraction unit 132.

The visit proposal place extraction unit 132 grasps the departure place and the destination from the schedule information and the information on the departure point. The visit proposal place extraction unit 132 extracts a plurality of places such as facilities, stores, and sightseeing spots that exist within a predetermined distance from a travel route from the departure place to the destination place from road map information stored in the storage unit 12. The road map information may be acquired from the external server. The visit proposal place extraction unit 132 transmits information on the visit proposal places to the terminal device 20 via the communication unit 11 using the extracted places as visit proposal places. When the information acquisition unit 131 acquires the SNS information of the user, the visit proposal place extraction unit 132 may analyze a behavior pattern, hobby information, and the like from the SNS information and estimate and propose a place matching an interest of the user.

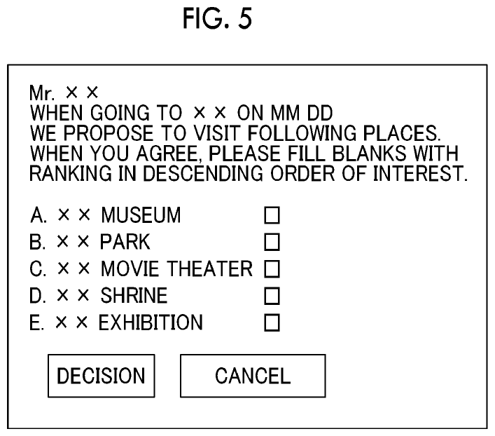

The terminal output unit 23 of the terminal device 20 outputs the information on the visit proposal place acquired from the course proposal device 10. The user responds to the degree of interest in the visit proposal place (ah visit proposal place the user desires to visit) according to the screen displayed on the terminal output unit 23. In FIG. 5, an example of a display of the information on the visit proposal place in the terminal output unit 23 is illustrated. In the example illustrated in FIG. 5, five places A to E are listed as the visit proposal places. In this case, the user responses with a ranking of the presented visit proposal places in an order of places that the user desires to visit. In the following description, information on the degree of interest responded by the user is referred to as “degree-of-interest information”, and a degree of interest of the user in the visit proposal place is simply referred to as a “degree of interest”. The degree-of-interest information is not limited thereto, and for example, may be obtained by scoring the degree of interest in each place.

When a departure time based on the schedule passes, the degree-of-interest change decision unit 133 decides whether or not the degree-of-interest changes as the environment changes while the vehicle is traveling, and outputs degree-of-interest change information indicating a decision result to the course proposal unit 134. Specifically, the degree-of-interest change decision unit 133 decides whether or not an environment affecting the degree of interest, such as weather at the visit proposal place, a degree of congestion of the visit proposal place, and a degree of congestion of a road directed to the visit proposal place, has changed. For example, the degree-of-interest change decision unit 133 decides that the degree of interest has changed according to a change in environment when it has rained at the visit proposal place, when a degree of congestion of the visit proposal place is a predetermined proportion or more, or when a degree of congestion of a road directed to the visit proposal place is a predetermined proportion or more. When the degree-of-interest change determination unit 133 decides that the degree of interest has changed, the degree-of-interest change decision unit 133 outputs degree-of-interest change information indicating that the degree of interest has changed to the course proposal unit 134.

The course proposal unit 134 determines a course to be proposed to the user, and transmits information on the determined course as course proposal information to the terminal device 20 via the communication unit 11. Specifically, the course proposal unit 134 first determines a degree of interest (an initial value before the degree-of-interest changes) for each place according to the degree-of-interest information that the information acquisition unit 131 has acquired from the terminal device 20. Then, the course proposal unit 134 calculates the course priority between the visit proposal places based on the degree of interest. The course proposal unit 134 may determine the courses in a descending order of the degree of interest, but it is desirable to consider a degree of distance importance indicating a measure of whether or not the user places importance on shortness of a driving distance. For example, the course proposal unit 134 calculates a course priority according to Equation (1) below. The course with the highest course priority is determined to be the course to be proposed to the user.

Course priority=degree of interest+(degree of distance importance/distance)×coefficient (1)

Here, the “distance” is a distance between the visit proposal places. The “degree of distance importance” is a numerical value of a measure of whether or not the user places importance on the shortness of the driving distance, and has a larger value as the degree of importance on the shortness of the driving distance is higher. The degree of emphasis of the distance differs depending on persons. Therefore, an entry column regarding the degree of distance importance may be displayed on the terminal output unit 23 of the terminal device 20 of the user, and the user may be caused to respond. Alternatively, a plurality of course proposals may be made, and a degree of distance importance may be learned from the course selected by the user and is fed back for learning the degree of distance importance suitable for a person. When a degree of priority of a course from the visit proposal place A to the visit proposal place B is calculated, “the degree of interest” in Equation (1) means a priority of the visit proposal place B.

Further, the course proposal unit 134 acquires degree-of-interest change information from the degree-of-interest change decision unit 133. When the degree-of-interest change decision unit 133 decides that the degree of interest has changed, the course proposal unit 134 obtains the changed degree of interest, and determines the course again based on the changed degree of interest and the distance of the visit proposal place. Specifically, the course priority is recalculated by Equation (1). When an order of a level of the course priority has changed, the course proposal unit 134 determines a new course, and transmits course proposal information to the terminal device 20 again through the communication unit 11 or to vehicle 30 through the communication unit 11. A change in a degree of interest according to the change of the environment is determined in advance, and the changed degree of interest is calculated, for example, using Equation (2). A weather weight, a visit proposal place congestion degree weight, and a road congestion degree weight are determined based on recorded statistical data of a change in the past number of visitors to a visit proposal place when an environment such as weather, a degree of congestion of a facility, a degree of congestion of a road has changed. Further, each weight may be obtained by analyzing big data of a plurality of users, or may be obtained by learning through machine learning for each user.

Changed degree of interest=initial value×weather weight×visit proposal place congestion degree weight×road congestion degree weight (2)

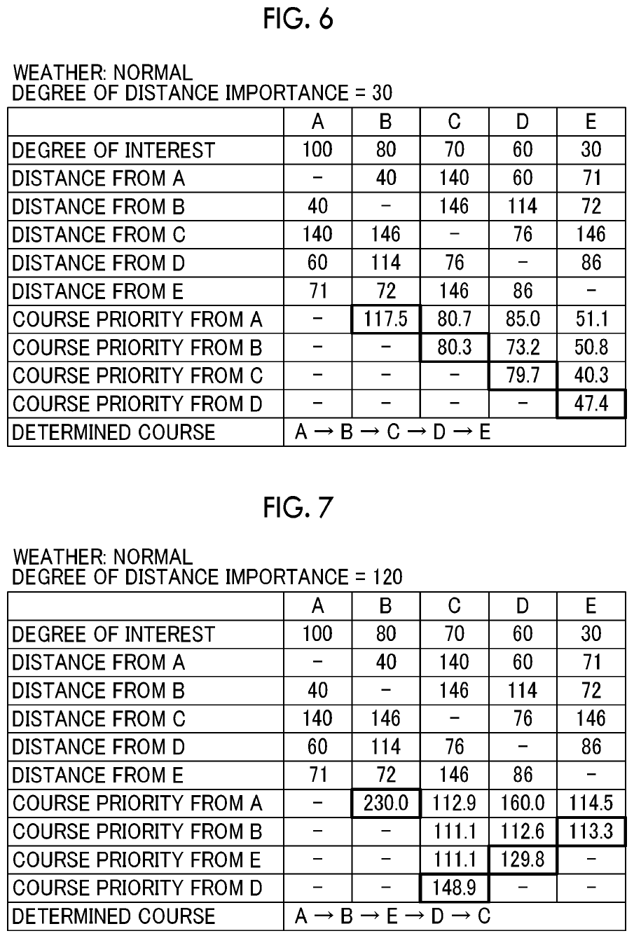

A specific example of course priority calculation and course determination will be described with reference to FIGS. 6 to 8. FIG. 6 is a diagram illustrating a first example of determining a course. In the example described below, it is assumed that the degree-of-interest information indicates that the degree of interest of the user for the visit proposal places A to E is level 1 to level 5 in an order of A, B, C, D, and E. Here, initial values of the degrees of interest of the visit proposal places A, B, C, D, and E are set to 100, 80, 70, 60, and 30, respectively, a degree of importance of a distance is set to 30, and a coefficient is set to 50. Further, a distance between the places is set as the distance illustrated in FIG. 6, and the place A with the highest initial value of degree of interest is set to a departure point. A course priority in this case is calculated as follows using Equation (1).

The course priority of the visit proposal places A-B is 80+(30/40)×50=117.5

The course priority of the visit proposal places A-C is 70+(30/140)×50=80.7

The course priority of the visit proposal places A-D is 60+(30/60)×50=85.0

The course priority of the visit proposal places A-E is 30+(30/71)×50=51.1

Among these, since the course priority of the visit proposal places A-B is the highest, a place to go next from the visit proposal place A is determined to be the visit proposal place B.

The course priority of the visit proposal places B-C is 70+(30/146)×50=80.3

The course priority of the vi sit proposal place B-D is 60+(30/114)×50=73.2

The course priority of the visit proposal place B-E is 30+(30/72)×50=50.8

Among these, since the course priority of the visit proposal places B-C is the highest, the place to go next from the visit proposal place B is determined to be the visit proposal place C.

The course priority of the visit proposal place C-D is 60+(30/76)×50=79.7

The course priority of the visit proposal places C-E is 30+(30/146)×50=40.3

Among these, since the course priority of the visit proposal places B-C is the highest, the place to go next from the visit proposal place C is determined to be the visit proposal place D. The place to go next from the visit proposal place D is the remaining visit proposal place E.

The course priority of the visit proposal places D-E is 30+(30/86)×50=47.4

From the above, the course proposal unit 134 determines the course to be proposed to be A→B→C→D→E.

FIG. 7 is a diagram illustrating a second example of determining a course. Here, the degree of distance importance is set to 120, and conditions other than the degree of distance importance are the same as those in FIG. 6. The course priority in this case is calculated as follows using Equation (1).

The course priority of the visit proposal places A-B is 80+(120/40)×50=230.0

The course priority of the visit proposal places A-C is 70+(120/140)×50=112.9

The course priority of the visit proposal places A-D is 60+(120/60)×50=160.0

The course priority of the visit proposal places A-E is 30+(120/71)×50=114.5

Among these, since the course priority of the visit proposal places A-B is the highest, a place to go next from the visit proposal place A is determined to be the visit proposal place B.

The course priority of the visit proposal places B-C is 70+(120/146)×50=111.1

The course priority for the proposed visit places B-D is 60+(120/114)×50=112.6

The course priority of the visit proposal place B-E is 30+(120/72)×50=113.3

Among these, since the course priority of the visit proposal places B-C is the highest, a place to go next from the visit proposal place B is determined to be the visit proposal place E.

The course priority of the visit proposal places E-C is 70+(120/146)×50=111.1

The course priority of the visit proposal places E-D is 60+(120/86)×50=129.8

Among these, since the course priority of the visit proposal places E-D is the highest, a place to go next from the visit proposal place E is determined to be the visit proposal place D. A place to go next from the visit proposal place D is the remaining visit proposal place C.

The course priority of the visit proposal places D-C is 70+(120/76)×50=148.9

As described above, the course proposal unit 134 determines the course to be proposed to be A→B→E→D→C. Thus, the course proposal unit 134 determines the course according to the degree of distance importance.

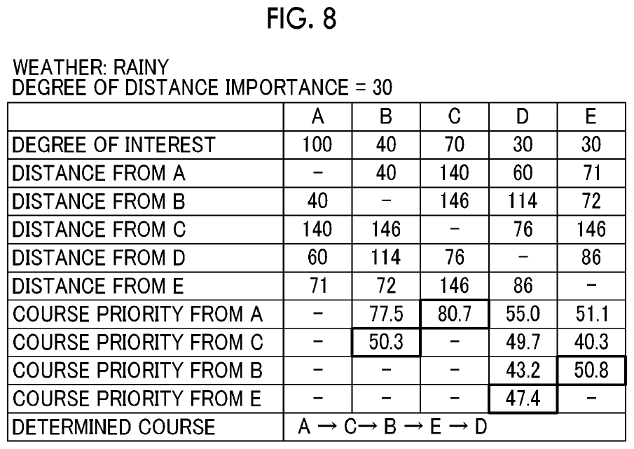

FIG. 8 is a diagram illustrating a third example of determining a course. Here, a weather weight in rainy weather is set to ½. That is, it is assumed that the degree of interest in outdoor visit proposal places B and D is reduced to ½ due to rain. Therefore, the degrees of interest of the visit proposal places A, B, C, D, and E are 100, 40, 70, 30, and 30, respectively. The degree of distance importance and the distance between the respective places are the same as those in FIG. 6.

The course priority in this case is calculated as follows using Equation (1).

The course priority of the visit proposal places A-B is 40+(30/40)×50=77.5

The course priority of the visit proposal places A-C is 70+(30/140)×50=80.7

The course priority of the visit proposal places A-D is 30+(30/60)×50=55.0

The course priority of the visit proposal places A-E is 30+(30/71)×50=51.1

Among these, since the course priority of the visit proposal places A-C is the highest, the place to go next from the visit proposal place A is determined to be the visit proposal place C.

The course priority of the visit proposal places C-B is 40+(30/146)×50=50.3

The course priority of the visit proposal places C-D is 30+(30/76)×50=49.7

The course priority of the visit proposal places C-E is 30+(30/146)×50=40.3

Among these, since the course priority of the visit proposal places C-B is the highest, the place to go next from the visit proposal place C is determined to be the visit proposal place B.

The course priority of the proposed visit places B-D is 30+(30/114)×50=43.2

The course priority of the visit proposal places B-E is 30+(30/72)×50=50.8

Among these, since the course priority of the visit proposal places B-E is the highest, the place to go next from the visit proposal place B is determined to be the visit proposal place E. The place to go next from the visit proposal place E is the remaining visit proposal place D.

The course priority of the visit proposal places E-D is 30+(30/86)×50=47.4

As described above, the course proposal unit 134 determines the course to be proposed as A→C→B→E→D. Thus, when the degree-of-interest changes, the course proposal unit 134 calculates the course priority again to determine a new course.

Further, the course proposal unit 134 may extract a meal place present within a predetermined distance with respect to the proposed course, and extract a meal place present within a predetermined distance with respect to a newly proposed course when the degree-of-interest change decision unit 133 decides that the degree of interest has changed, and include the meal place in the course proposal information. In such a case, the course proposal unit 134 extracts a meal place present near an area on the course in which the vehicle 30 is expected to pass at a predetermined time. For example, a meal place to be recommended for lunch near an area on the course in which the vehicle 30 is expected to pass between 11:00 and 13:00 is extracted. When the information acquisition unit 131 has acquired the SNS information of the user, the course proposal unit 134 may analyze preference of a meal of the user from the SNS information, and estimate and extract a meal place matching the preference of the user.

When the course proposal unit 134 proposes a course, the course proposal unit 134 may decide whether or not the course is in time for an arrival time of the destination and an available visit time (a business hours of a store, a use time of a facility, or the like) of each visit proposal place. When the course proposal unit 134 decides that the course is not in time, the course proposal unit 134 may delete a visit proposal place with a low degree of interest from a plurality of visit proposal places, and propose a course to be in time for the arrival time of the destination and the available visit time of the remaining visit proposal place. A stay time of each visit proposal place may be estimated based on statistical information, and a screen for confirming a scheduled stay time of each visit proposal place may be displayed on the terminal output unit 23 so that the user responds.

Flow of Course Proposing Method

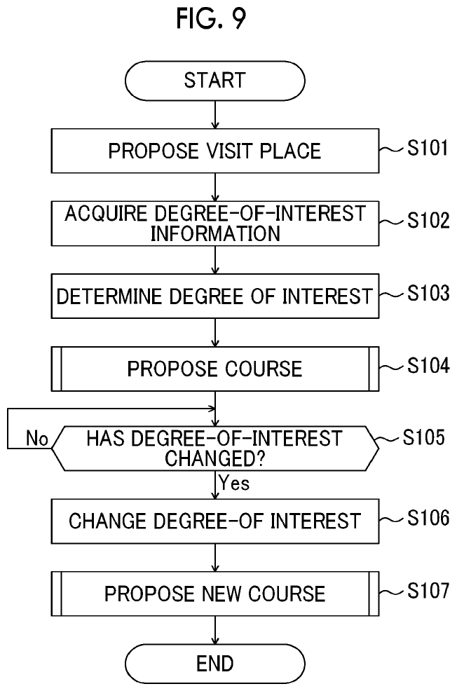

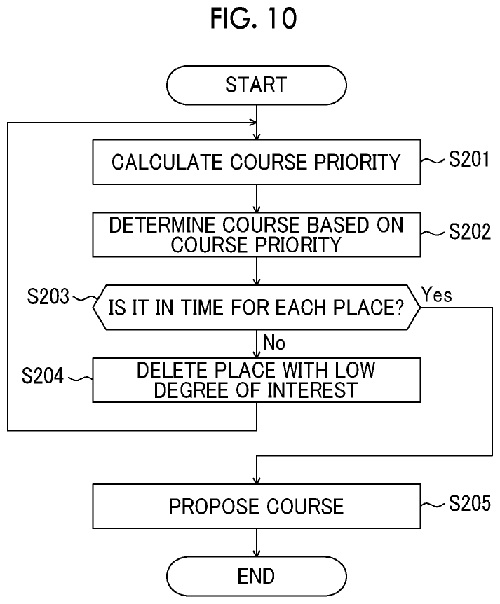

Next, a flow of the course proposal method of the course proposal device 10 will be described with reference to FIGS. 9 and 10. FIG. 9 is a flowchart illustrating an overview of the course proposal method. FIG. 10 is a flowchart illustrating an example of a specific method of determining a course.

Step S101: The visit proposal place extraction unit 132 extracts a plurality of visit proposal places and transmits information on the visit proposal places to the terminal device 20 via the communication unit 11 to propose the visit places.

Step S102: The information acquisition unit 131 acquires degree-of-interest information from the terminal device 20 via the communication unit 11.

Step S103: The course proposal unit 134 determines the degree of interest for each visit proposal place extracted in step S101 according to the degree-of-interest information acquired in step S102.

Step S104: The course proposal unit 134 proposes a course based on the degree of interest determined in step S103.

Details of an operation in step S104 will be described with reference to FIG. 10.

Step S201: The course proposal unit 134 calculates the course priority between the visit proposal places based on the degree of interest determined in step S103. In this case, it is desirable to consider the degree of distance importance of the user. The course proposal unit 134 calculates a course priority, for example, using Equation (1) above.

Step S202: The course proposal unit 134 determines the course with the highest priority based on the course priority calculated in step S201. Further, the course proposal unit 134 may extract a meal place present within a predetermined distance with respect to the proposed course, and create a course including the meal place.

Step S203: The course proposal unit 134 decides whether or not the course is in time for the arrival time of the destination and the available visit time of each visit proposal place when acting is taken according to the course determined in step S202.

Step S204: When there is a visit proposal place in which it is assumed that the course is not in time for the arrival time of the destination or the course is not in time for the available visit time (step S203-No), the course proposal unit 134 deletes a visit proposal place with a low degree of interest from the visit proposal places extracted in step S101. The processes of step S204, step S201, and step S202 are repeatedly performed until the course proposal unit 134 decides in step S203 that the course is in time for the arrival time of the destination and the available visit time of each remaining visit proposal place.

Step S205: When the course proposal unit 134 decides whether or not the course is in time for an arrival time of the destination and an available visit time in step S203 (step S203-Yes), the course proposal unit 134 transmits the course determined in step S202 to the terminal device 20 via the communication unit 11.

Description will be made again with reference to FIG. 9.

Step S105: When the departure time based on the schedule passes, the degree-of-interest change decision unit 133 continuously decides whether or not the degree of interest has changed.

Step S106: When the degree-of-interest change decision unit 133 decides in step S105 that the degree of interest has changed (step S105-Yes), the course proposal unit 134 changes the degree of interest using, for example, Equation (2) above.

Step S107: The course proposal unit 134 proposes a new course based on the degree of interest changed in step S106. Since a process of step S107 is the same as the process of step S104, a description thereof will be omitted.

As described above, the course proposal device 10 according to the embodiment extracts a plurality of places present within a predetermined distance from the travel route to the destination as a visit proposal place, presents the places to the user, and acquires information indicating a degree of interest of the user in the proposal place. The course proposal device 10 determines a course to be proposed to the user based on the degree of interest. When the course proposal device 10 decides whether or not the degree of interest has changed due to a change in the environment, the course proposal device 10 newly proposes to the user based on the changed degree of interest. With this configuration, when the degree of interest of the user in the scheduled visit place has changed with change in the environment after the vehicle 30 starts traveling, the course proposal device 10 can propose a new course to the user each time.

Further, the course proposal device 10 may determine the course in consideration of the degree of distance importance. Accordingly, the course proposal device 10 can propose a course suitable for each user. For example, the course proposal device 10 proposes a course with a short driving distance to a user who is not good at long-distance driving.

Further, the course proposal device 10 may extract the meal place present within a predetermined distance with respect to the proposed course. Accordingly, the course proposal device 10 can also propose the meal place to the user, and the user can omit efforts of searching for the meal place.

Further, the course proposal device 10 may decide whether or not the course is in time for the arrival time of the destination and the available visit time of the visit proposal place when proposing the course, delete a visit proposal place with a low degree of interest from the visit proposal places when the course proposal device 10 determines that the course is not in time, and determine a course such that the course is in time for the arrival time of the destination and the available visit time of the remaining visit proposal place. Accordingly, the course proposal device 10 can propose a place that the user can visit reliably, and can also prevent arrival at the destination from being delayed unlike a schedule.

Although the course proposal device 10 has been described above, a computer can be suitably used to function as the course proposal device 10. Such a computer is realized by storing a program in which processing content realizing the function of the course proposal device 10 has been described in a storage unit of the computer and reading and executing this program by a CPU of the computer.

Further, this program may be recorded on a computer-readable medium. When the computer-readable medium is used, the program can be installed in a computer. Here, the computer-readable medium having the program recorded thereon may be a non-transitory recording medium. The non-transitory recording medium is not particularly limited, but may be, for example, a recording medium such as a CD-ROM or a DVD-ROM.

Although the embodiment described above has been described as a representative example, it will be obvious to those skilled in the art that many modifications and substitutions can be made within the spirit and scope of the present disclosure. Therefore, an applicable embodiment of the present disclosure should not be construed as being limited by the above-described embodiment, and various modifications and changes are possible without departing from the scope of the claims. For example, a plurality of respective components or steps described above can be combined into one or each of the components or steps may be divided into a plurality of ones.

What is claimed is:

1. A course proposal device comprising:
a visit proposal place extraction unit configured to extract a plurality of places present within a predetermined distance from a travel route to a destination as visit proposal places;
an information acquisition unit configured to acquire information indicating a degree of interest of a user in the visit proposal place;
a degree-of-interest change decision unit configured to decide whether or not the degree of interest has changed with a change in an environment; and
a course proposal unit configured to determine a course to be proposed to the user based on the degree of interest, wherein:
the course proposal unit determines a course to be newly proposed to the user based on the changed degree of interest when the degree-of-interest change decision unit decides that the degree of interest has changed.

2. The course proposal device according to claim 1, wherein the course proposal unit determines the course in consideration of a degree of distance importance indicating a measure of whether or not the user places importance on the shortness of the driving distance.

3. The course proposal device according to claim 1, wherein the course proposal unit extracts a meal place present within a predetermined distance from the course to be proposed.

4. The course proposal device according to claim 1, wherein the course proposal unit determines whether or not the course is in time for an arrival time of a destination and an available visit time of a visit proposal place when proposing the course, deletes a visit proposal place with a low degree of interest from a plurality of the visit proposal places when the course proposal unit determines that the course is not in time, and determines a course to be in time for the arrival time of the destination and an available visit time of a visit proposal place after the deletion.

5. The course proposal device according to claim 1, wherein the degree-of-interest change decision unit decides that the degree of interest has changed when at least one of weather, a degree of congestion of the visit proposal place, and a degree of congestion of a road has changed.

6. A course proposal method comprising:
a visit proposal place extraction step of extracting a plurality of places present within a predetermined distance from a travel route to a destination as visit proposal places;
an information acquisition step of acquiring information indicating a degree of interest of a user in the visit proposal place;
a degree-of-interest change decision step of deciding whether or not the degree of interest has changed with a change in an environment; and
a course proposal step of determining a course to be proposed to the user based on the degree of interest, wherein:
the course proposal step includes determining a course to be newly proposed to the user based on the changed degree of interest when a decision is made in the degree-of-interest change decision step that the degree of interest has changed.

7. A program causing a computer functioning as a course proposal device to execute:
a visit proposal place extraction step of extracting a plurality of places present within a predetermined distance from a travel route to a destination as visit proposal places;
an information acquisition step of acquiring information indicating a degree of interest of a user in the visit proposal place;
a degree-of-interest change decision step of deciding whether or not the degree of interest has changed with a change in an environment; and
a course proposal step of determining a course to be proposed to the user based on the degree of interest, wherein:
the course proposal step includes determining a course to be newly proposed to the user based on the changed degree of interest when a decision is made in the degree-of-interest change decision step that the degree of interest has changed.
